(19) United States
(12) Patent Application Publication
(10) Pub. No.: US 2006/0190318 A1
(43) Pub. Date: Aug. 24, 2006

(54) System and method for identifying and measuring performance discrepancies among sales territories

(76) Inventors: Thimothy W Downey, Broomall, PA (US); Richard D Pollack, Newtown, PA (US)

Correspondence Address: BAKER & BOTTS, 30 ROCKEFELLER PLAZA, 44TH FLOOR, NEW YORK, NY, 10112, US

(21) Appl. No.: 10/518,571

(22) PCT Filed: Jul. 2, 2002
(86) PCT No.: PCT/US02/20863

§ 371 Date: Dec. 2, 2005

(51) Int. Cl. G06F 17/30

(52) U.S. Cl. 705/10

(57) ABSTRACT

A system for measuring performance discrepancies (101). The system (includes a display). (102), such as a monitor, which permits a user to view data, to interact with the process and to view the results of the process. The system includes a system processor (103), for processing data according to instructions encoding the process. In addition, computer memory (104) can be provided to facilitate the processing of data by the system processor. The system includes a set of instructions for measuring performance discrepancies (105). The discrepancies (105) can be hard-coded into computer storage devices such as a computer hard drive. The instructions (105) can communicate with the system processor (103) via conventional computer communication including network communications such as Internet.

### BACKGROUND OF THE INVENTION

1. Field of the Invention

The present invention relates generally to systems and methods for identifying and measuring performance discrepancies among sales territories and more particularly relates to computer based systems and methods for identifying and measuring performance discrepancies among sales territories in the pharmaceutical industry utilizing an automatic interactive detector.

2. Description of Related Art

The acquisition and analysis of marketing data is essential to numerous marketing and business planning operations of a product distributor. A distributor's decision to maintain, increase or decrease the distributor's sales force is often based upon the effectiveness of the sales force in promoting the distributor's product or products. However, to monitor the effectiveness of a sales force, performance data should be analyzed in a manner that considers the territory covered by the sales force as well as the volume of the product sold, the product's market share, the number of competitive products, change in sales over a period of time, change in sales by territory, the total number of promotional events such as sales calls within a territory, and the forecasted number of promotional events within a territory, among other things. Unfortunately, conventional analysis techniques often are misleading because they fail to emphasize the most relevant factors for analysis and can over-emphasize less relevant factors.

Sales force individuals engage in various sales activities, or events, to promote their products. Sales force individuals can include medical information scientists (“MIS”) who are particularly knowledgeable of a particular product or products. Sales events include cold calls, promotions, and sales. For example, in the pharmaceutical industry, MIS and sales force individuals contact Thought leaders in the relevant market for their product to inform them about the products for sale and to promote their particular product.

Thought leaders are individuals in a particular field of interest who are regarded by others in that field, such as drug prescribers, as having expertise or special knowledge of the subject of interest. Thought leaders often provide advisory or consultative roles and their treatment approaches are often adopted by prescribers. Based on these promotional efforts, Thought leaders can impact the prescribing decisions of others, such as physicians within their geographical area. Since Thought leaders provide indirect influence on purchasing decisions, as opposed to selling the products themselves, known methods of sales analysis fail to assess the promotional effectiveness of sales contact through thought leaders.

### SUMMARY OF THE INVENTION

It is an object of the present invention to provide a technique which permits a producer or distributor of a product to understand the effectiveness of its sales force in influencing the opinion of the consumer market with regard to the product being sold. In a particular application to the pharmaceutical sales market, it is important to understand the effectiveness of applying MIS and salespersons to inform and educate Thought leaders and thereby to understand the effectiveness of this sales technique in promoting sales to the ultimate consumer or prescriber. Furthermore, it is important for a producer or distributor of a product to understand the degree of influence or spillover that an informed thought leader has upon the purchasing decisions of the consumer or prescriber. Accordingly, it is also an objective of the present invention to provide a technique which undertakes a segmentation and sizing analysis to ensure that the most relevant Thought leaders are identified for sales contacts.

Another objective of the present invention is to permit a producer or distributor to analyze the effectiveness of a sales force in a particular segment of a larger market, such as the therapeutic markets for cardiology, neurology, and infectious diseases. Through such segmentation analysis, a producer or distributor can optimize the size of its sales force and allocate MIS and sales individuals according to market segment.

The systems and methods according to the present invention utilizes predictive modeling and data-mining techniques to better understand the effectiveness of a sales force over various periods of time and over different designated sales territories. Thus, it is an objective herein to provide techniques that effectively and systematically quantify the root causes of any differences in sales effectiveness. For example, in the pharmaceutical industry, such causes can include demographics of a pharmaceutical prescriber, population demographics of a sales territory, prescribing trends over a period of time, managed care influence, among other things. Such an analysis is valuable for effectively adjusting sales force numbers and techniques, optimizing the use of sales force resources, and determining the return on investment on sales resources for products among other things. Therefore, an objective of the present invention is to provide an exhaustive modeling technique for optimizing sales force effectiveness.

In accordance with the present invention, a technique for analyzing sales performance is provided which includes an exhaustive Chi-squared automatic interactive detection (“CHAID”) algorithm. Decision tree algorithms are typically employed to segment to groups of respondents that share similar characteristics. However, it has not been known to segment territories whether or not they are performing well with particular therapies. The algorithm is exhaustive in the recursion analysis because it examines all combinations and permutations of variables. Accordingly, the algorithm is able to maximize segmentation and uncover segments not detected by more traditional techniques such as cluster analysis.

Advantageously, the system for measuring performance discrepancies according to the invention provides a way to monitor sales force performance across predetermined measures. Examples of such measures and other data for analysis include product volume, product market share, sales growth against previous time periods, sales growth across geographical regions, total number of sales calls, and number of actual calls relative to projected calls.

Techniques adapted for analysis of the pharmaceutical industry provide for a pharmaceutical company or distributor to analyze the effectiveness of its sales force, and for monitoring of the effectiveness of the sales force periodically, thereby permitting the producer or distributor to adjust the focus or size of its sales force for optimal sales effectiveness. Accordingly, in a preferred aspect of the present invention, a computer based method for measuring performance discrepancies among sales territories is provided. The method includes the steps of maintaining a database of market data, summarizing market data according to sales territory, performing a partitioning analysis of the summarized market data to determine a plurality of nodes for identifying significant segmentation variables, and associating market data with each partitioned node.

The computer based method can further include the step of retaining an association between market data and each partitioned node as an additional segmentation variable and performs a recursive partitioning analysis. Preferably, the step of performing a partitioning analysis includes the steps of entering additional segmentation variables, and performing a recursive partitioning utilizing an exhaustive Chi-squared automatic interactive detector. After partitioning, the method can include displaying the plurality of nodes in a node tree.

A system according to the invention for measuring performance discrepancies among sales territories is provided comprising a memory device for storing a computer program and a data processor for processing a set of computer instructions.

The data processor maintains a database of market data, and summarizes market data according to sales territory. In addition, the processor performs a partitioning analysis of the summarized market data to determine a plurality of nodes for identifying significant segmentation variables, and associating market data with each partitioned node.

The processor can further retain an association between market data and each partitioned node as an additional segmentation variable. The processor preferably performs a partitioning analysis and displays the plurality of nodes in a node tree to a user.

These and other features and objects of the invention will be apparent from the description of the preferred embodiments, which is to be read in conjunction with the accompanying drawings.

### BRIEF DESCRIPTION OF THE DRAWINGS

FIG. 1 is a block diagram of a system in accordance with the present invention for identifying and measuring performance discrepancies among sales territories;

FIG. 2 is a flow chart illustrating several steps of a method for analysis and for identifying and measuring performance discrepancies among sales territories;

FIG. 3 is an exemplary diagram of an output display showing a node tree; and

FIG. 4 is an output display showing a graph identifying variable distribution by category for further potential partitioning.

Throughout the figures, the same reference numerals and characters, unless otherwise stated, are used to denote like features, elements, components or portions of the illustrated embodiments.

### DETAILED DESCRIPTION OF PREFERRED EMBODIMENTS

The present invention provides techniques for identifying and measuring performance discrepancies among sales territories. The present invention is described herein as a computer based system and method adapted for identifying and measuring performance discrepancies among sales territories in the pharmaceutical industry. However, it can be appreciated that the system and method can be adapted for analysis of other market systems as well.

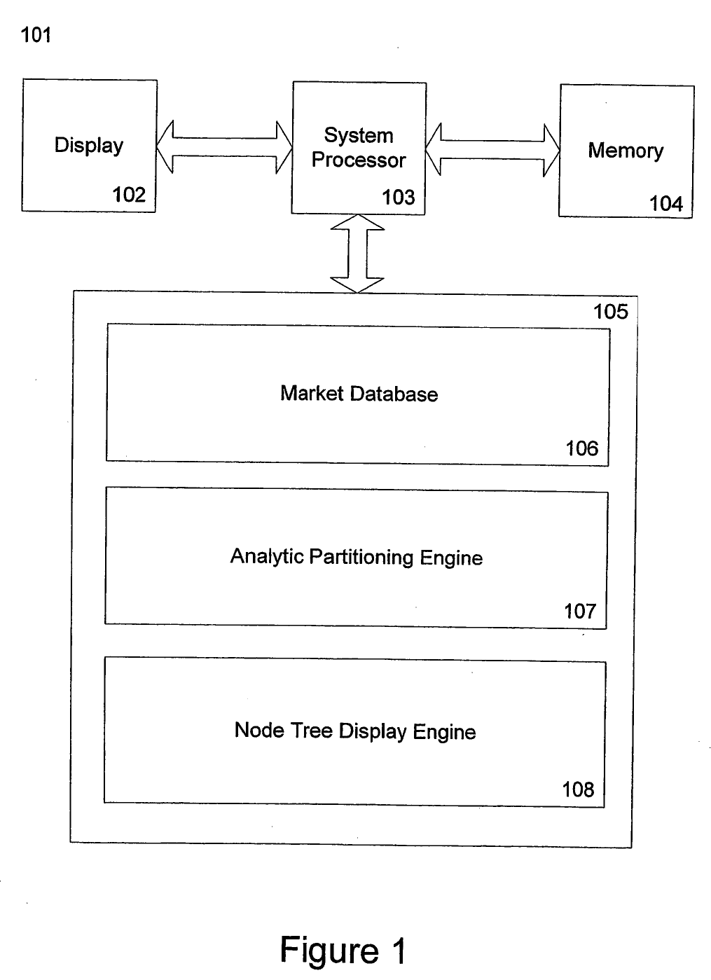

FIG. 1 depicts a block diagram of a system for measuring performance discrepancies 101 according to the invention. The system 101 includes a display 102, such as a monitor or CRT, which permits a user to view data, to interact with the process and to view the results of the process. The system 101 also includes a system processor 103, such as a microprocessor, for processing data according to instructions encoding the process according to the invention. In addition, computer memory 104 can be provided to facilitate the processing of data by the system processor 103.

The system 101 also includes with a set of instructions for measuring performance discrepancies 105. The instructions 105 can be hard-coded into computer circuitry or they can be provided as software that can be stored in conventional software storage devices such as a computer hard drive, removable computer readable magnetic media, or a computer's RAM. The instructions 105 can communicate with the system processor 103 via conventional computer communications including network communications such as the Internet.

The instructions for measuring performance discrepancies 105 should include several software modules encoded with instructions for the several processes of the method, such as maintaining a market database 106, providing an analytic partitioning engine 107, and providing a node tree display engine 108. Instructions for maintaining a market database 106 can be specifically provided for maintaining the records of a database used for storing data to be used by the system and method. Conventional database software such as Microsoft® Access® can be used for this purpose. In addition, instructions for an analytic partitioning engine 107 can be specifically provided for performing the partitioning processor of the method according to the invention. A display engine 108 is provided to display views of the data and results of the process according to the invention, such as displaying the information as part of a node tree. The analytic partitioning engine 107 and node tree display 108 can be provided in part as software written in the “C” language and can include other commercially available software as further described herein.

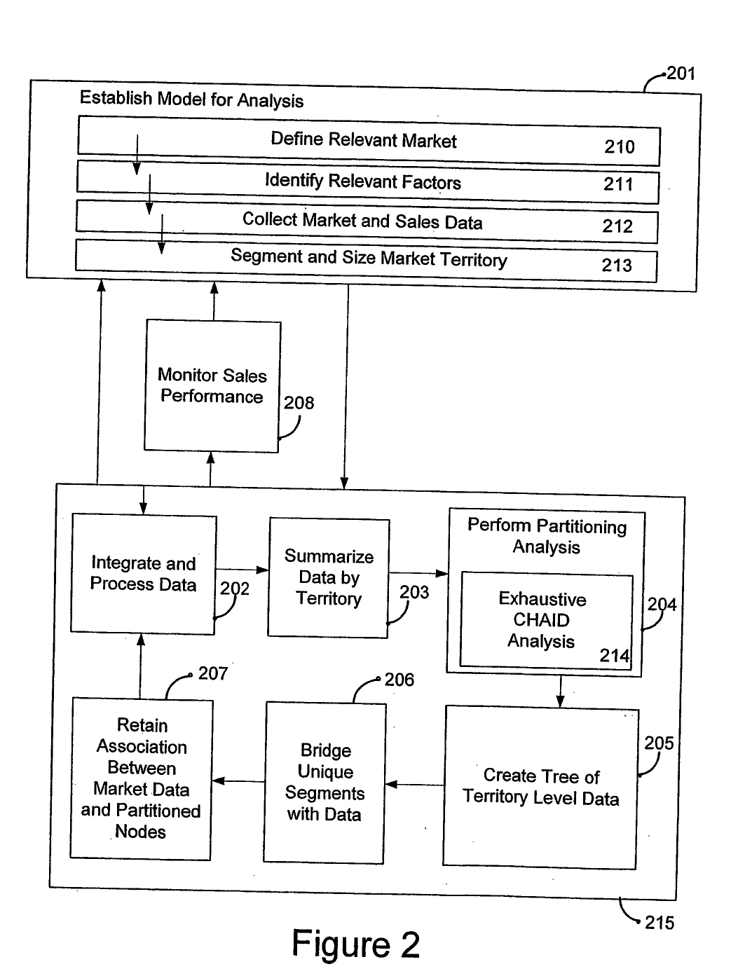

FIG. 2 is a simplified flow chart illustrating a method for identifying and measuring performance discrepancies among sales territories in accordance with the invention.

The first step in the method is to establish a model for analysis 201. The process of establishing a model for analysis 201 can include a number of sub-steps such as defining a relevant market for analysis 210 of a particular product or products. The relevant market for the product can include one or more products sold by a producer or distributor as well as one or more competing products. In addition, a market can be defined according to a predefined geographic region, among other things.

A second sub-step of the process can be identifying the relevant factors for analysis 211. Relevant factors can vary according to market. Accordingly, a part of identifying relevant factors 211 can be to categorize quantifiable sales activities in order to capture the activities of a sales force promoting a product or products. For example, some categorizations of sales promotions can include off-label sales initiatives, types of sales contacts, such as mailing or direct calls made to thought leaders, promotional events such as clinical trial recruitment and oversight. Other information, such as timing and content of sales contacts with Thought leaders can also be associated with a category.

In a specific example in the pharmaceutical industry, the step of identifying relevant factors 211 includes investigating characteristics of Thought leaders for inclusion into the market database 106. Accordingly, a part of investigating thought leader characteristics can be to categorize quantifiable and non-quantifiable thought leader characteristics in the relevant market that can be later used as segmentation variables. MIS and sales individuals who have chosen Thought leaders from among others in their respective areas are surveying, and a best practices list of what factors they considered to be important in defining an individual as a thought leader is compiled. Alternatively, or in addition, interviews with one or more Thought leaders can provide additional criteria for selecting a thought leader. In addition, data can be obtained to describe other information related to MIS and sales individuals to be stored as additional factors. Such data can include calls or contacts made to MIS and sales individuals, prescriber profile information, as well as sales of products by prescriber and territory. For example, territory data taken for several sequential quarter years can be utilized. Other data for additional factors can include thought leader profile information, such as leader name, thought leader characteristics and territory description.

Some criteria can include whether the potential thought leader is a committee member, whether the individual is a department chairperson, or a clinical investigator. Further characteristics include whether the individual is a recognized medical leader or expert within a segment of the market. For example, an individual being recognized as an expert within a therapeutic category, such as cardiology, could be a factor. Another type of factor can be whether the thought leader is involved in treatment decision making, as well as whether the individual possesses broad product and clinical experience and whether or not the individual is a good communicator. These thought leader characteristics populate the market database 106 which can then be subject to analysis with other market factors. Other types of segmentation variables that can be used depend upon the specific nature of the market.

Another part of the step of identifying relevant factors 111 of the market is identifying predetermined characteristics of the territory being analyzed for inclusion into the market database 106. These characteristics can include prescriber demographics, population demographics, prescribing trends and managed care influence.

A third sub-step in process of establishing a model for analysis 101 includes collecting market and sales data 212 for the relevant factors and thought leader characteristics previously identified thereby populating the market database 106 with data.

A fourth sub-step in the process of establishing a model 101 is segmenting and sizing of the market territory 213. Once segmented, a factor reflecting the segmentation information can be stored in the market database 106. For example, in a pharmaceutical model, once thought leader data has been obtained, it is possible to segment the territory into several sub-territories, each influenced by a thought leader. Each territory can also be segmented by geographic location, or by a combination of products, or by therapeutic fields, among other things. Where segmentation is performed according to thought leader, segmentation can be done by first identifying Thought leaders according to specific criteria within the relevant market for the analysis. Identification should be done by matching a database having records of individuals in the relevant market having characteristics matching those criteria previously identified 211 as important for characterizing a thought leader.

Segmentation is used to divide the universe of prescribers within the entire market into a manageable number of thought leader territories. The relevant market is divided into segments using statistical, demographic, and neural clustering methods, and is further described below with regard to the analytic partitioning engine 107. A result is that a set of distinct consumer groups is defined, each group being made up of prescribers that are similar across one or more prescribed profile characteristics. The defined segments of the market become the unit of analysis to measure reach and frequency. Thereafter, it is possible to provide an optimal field deployment of MIS and sales individuals within the market segments. Although the step of segmenting market territory 213 has been described as part of the step of establishing a model for analysis 201, portions or all of the step of segmenting market territory 213 can be provided as a part of a process for recursive partitioning 215 utilizing an exhaustive Chi-squared automatic interaction detector.

A second part of the method shown in FIG. 1 is a recursive partitioning process 215. In a first step of recursive partitioning process 215, raw prescriber-level data from the market database 106 is processed. The process has been used to integrate client-provided target lists and sales call history with proprietary data sources such Xponent®, Xponent® PlanTrak™, and Formulary Focus™. These data sources are combined at the individual prescriber level and appropriate shares, trends, and other metrics are calculated and stored in the market database 106. Other databases can likewise be used.

A second step of the recursive process 215 is summarizing data at the territory level 203. The data that has been previously integrated and processed 202 is summarized by this step according to an associated territory. As discussed above, a territory can be a set of geographically contiguous zip codes that are covered by one or more sales representatives for the pharmaceutical company of interest. Thus, general characteristics of the territory can be generated and stored in the market database 106.

A further step provided by the method according to the invention is a partitioning analysis 204. A part of the partitioning analysis 204 utilizes predictive modeling and data mining techniques. A result of the modeling is that territories with performance measurements outside of a pre-established normal range for a measurement are identified. Commercially available statistical software program can be used to analyze data, such as territory level data sets. For example, a statistical program can use the total number of salesperson calls and total number of non-salesperson calls as its independent variables and use total territory prescriptions as the dependent variable for a multiple regression analysis. The model running a multiple regression analysis then yields coefficients for each of the independent variables, which includes variables representing the total territory impact of calls made to thought leaders.

In addition, the partitioning analysis 204 can include a multiple regression analysis using a thought leader segmentation variable as an additional independent variable. The results of the regression analysis provide parameter estimates, which can be compared against each other. A set of differences can be obtained to measure the magnitude of the difference between the several parameter estimates. The results of the regression model can be incorporated into a generation of response curves. Thus, the process systematically analyzes the root causes of the differences in actual and expected performance measurements.

As part of the partitioning analysis 204, an Exhaustive CHAID recursive analysis 214 is utilized. Exhaustive CHAID (Chi-squared Automatic Interaction Detector) is an analytic engine based on a decision tree algorithm that drives the territorial aspect of the analysis 204. Decision tree algorithms are part of a larger class of algorithms that fall under the rubric of recursive partitioning, where the splitting rule is applied to smaller and smaller partitions of the sample space. Recursive partitioning has been used with tree-based models for predicting continuous or categorical outcomes for a given set of independent variables. Independent variables or predictors, can be a mixture of discrete or continuous variables. Recursive partitioning divides a covariate space into distinct regions according to a specified variable. Thus, each instance of data within a region are more similar to the specified variable than instances of data in other regions. A tree-based model of partitioning, such as provided by exhaustive CHAID, utilizes a series of binary splits to partition data into subsets. Each node is a set of data in the tree wherein the data within a node share a general characteristic. As the tree branches and further nodes are created, the data within such nodes become more homogenous according to their specified characteristics. The splitting rule determines the characteristic by which a node is split into two further nodes. A stop-splitting rule should be used to limit the size of the tree and thus sets a characteristic rule for a terminal node.

Decision tree algorithms, such as Exhaustive CHAID, are typically employed to segments groups of data that share similar characteristics. However, generally splitting rules are only locally optical and cannot individually guarantee that the final tree will be globally optimized. Exhaustive CHAID provides an unusually effective tool for finding opportunity in large sets, especially those that consist primarily of categorical data, such as used in the pharmaceutical model. Exhaustive CHAID provides unusual results because it can be used to segment territories, whether they are performing well with particular therapies or not. Further benefits are achieved when the process integrates client-provided target lists and sales call history with data sources such as LRx®, Xponent®, Xponent® PlanTrak™, Integrated Promotional Services, HMO Indices™, and Formulary Focus™.

SPSS AnswerTree® 3.0 software is one commercially available software that provides an exhaustive CHAID algorithm. The specific description of this algorithm, and references for the work that underlie its modeling procedures can be found in AnswerTree® 3.0 User's Guide (Chicago: SPSS, Inc., 2001).

Alternative algorithms for processing the data include regular CHAID, C&RT (Classification and Regression Tree), QUEST (Quick Unbiased Efficient Statistical Tree), and See5/C5.0. These algorithms, however, typically do not have the extensive search capabilities of Exhaustive CHAID, which test all combinations and permutations of variables. Exhaustive CHAID provides a much higher probability of detecting a viable segment compared to other such algorithms and is specially suited for this portion of the analysis by providing unusually effective results.

The CHAID algorithm is exhaustive because it examines all combinations and permutations of variables. For example, physician age may not be a significant variable in narrow age groups such as 28 to 38, 39 to 49, 50 to 59, 60 to 69 and 70 and above. However when levels are combined, such as 20 to 38 and 50 to 69 then the variable can become significant. Thus, by combining categories of variables it is possible for the algorithm to include only statistically significant variables while avoiding the previous problem of overestimating effects.

The partitioning analysis 204 can analyze both categorical data such as geography, specialty, as well as continuous data. The algorithms of the partitioning analysis 204 can also be provided with a variable reduction tool which can be used as a precursor for higher order predictive models. Furthermore, the algorithm of the partitioning analysis 204 can be provided to exclude variables that are statistically insignificant, correct for chance findings, provide optimal splits for variables, and provide techniques to determine specified segmentation variables for accurate targeting.

As another part of the partitioning analysis 204, other information can be extracted for use as factors in the market database 106 or for display to a user to facilitate determination of segment variables. The results of the regression model can be compared with the cost of the several input variables such as cost per call. Accordingly, the output of the regression model can be expressed in a dollar value. Furthermore, a return on investment (ROI) value can be provided as an expression of the,results. Another value that can be calculated is optimal sales force size. Based upon a number of thought leader segments created, a total number of calls is calculated. Given a predefined estimate of call capacity, the total number of calls can be converted into an optimal sales force size. Where call capacity is determined by estimating the number of days per month and calls per day are made by each sales representative.

partitioning analysis 204 can also incorporate a process for identifying segments of prescribers in the market according to the characteristics discussed above through clustering methods. In addition, the partitioning analysis 204 can measure territory performance longitudinally. This measurement can provide information related to the impact of changes in promotional strategies on product performance.

In another step of the recursive process 215, the results of the territory level segmentation are processed and displayed in tree form 205, which can be shown to a user on a computer display 102. Although shown separately here, the processing and display of the results in tree form 205 can be provided as part of the partitioning analysis 204. In addition, the step of creating of the tree 205 can be skipped until later iterations of the recursive process 215.

FIG. 3 shows an example of a portion of an Exhaustive CHAID output in tree form on the territory level for a few nodes. Node zero (0) indicates that the market share for a drug, for example, Effexor®, in the entire antidepressant drug market, is 11.83% on a yearly basis. In node 42, the Effexor market share among Primary Care Physicians (PCPs) in a group of 36 territories, with total annual Serzone prescriptions of 1,118 or fewer, is 7.57%. This demarcates over a 4% drop from the overall market share of 11.83%. These territories would thus be considered weak in terms of Effexor market share. On the other hand, in Node 42, in which a group of 240 territories with psychiatrists (PSY) having more than 3.99 products constituting the top 80% of their prescriptions, market share is shown to have increased from 11.83% overall to 14.86%. These territories would thus constitute a strong market for Effexor.

FIG. 4 shows an example of a display that can be shown when a user has clicked on Node 41 shown in FIG. 3. An interactive visualization tool can be provided as part of the process of creating and displaying the tree 205 to allow a user to have the capability to click on any of the nodes to cause maps to appear with corresponding territories highlighted.

In another step of the recursive process 215, unique segments are bridged or linked with data 206. Associated data is preferably non-partitioned data that has not been subjected to a splitting rule in the partitioning step 204. Once segments have been developed by the partitioning step 204, the data processed by the integration steps 202 can be associated with appropriate nodes of the tree. Since, general partitioning analysis 204 can find significant and meaningful differences between a set of nodes, it does not mean that other differences of note do not exist. Accordingly, the system and method provides a visualization tool to view additional data associated with a node provided through the bridging step 206. Thus, a user is provided with the ability to designate additional factors to facilitate analysis of other differences. For example, all of the raw data for the prescribers that fell into the territories making up Node 41 can be grouped together for additional analysis. As shown in FIG. 4, a user is provided with the ability to consider the distribution of doctors in. Node 41 by group practice or gender, and compare these distributions against other nodes.

As an additional step of the recursive process 215, new partitions are retained 207 as an additional segmentation variable to be stored in the market database 106 and thus are utilized in a next iteration of the process 215. In subsequent runs of the recursive process 215, the node assigned to each prescriber within each territory can thus be associated in the raw prescriber level data, and can be processed along with other data Accordingly, it is possible to track longitudinal movements of territories across nodes.

Another step of the recursive process 215 that can be included is a step of monitoring sales performance 208. Since a purpose of the model is to first measure performance of a sales force and their thought leader targets, the method also provides for monitoring of sales performance and updating of performance measurement results. Thus, new and updated data can be entered into the market database 106 and the recursive process 215 can thereafter be again used for an analysis of the updated data. The process of monitoring sales performance can be provided to track changes in data over time and to track the results of the recursive process 215.

Specific factors that can be monitored in conjunction with sales performance measurements include territory market share, territory market share growth to account for new prescribers, formulary approvals, Hospital P&T approvals, and other key parameters. In addition, the step of monitoring sales performance can also include discovering additional qualitative factors and obtaining the respective data for incorporation into the model.

The invention has been described in connection with certain preferred embodiments. It will be appreciated that those skilled in the art can modify such embodiments without departing from the scope and spirit of the invention which is set forth in the appended claims.

1. A method for measuring performance discrepancies among sales territories, comprising the steps of:
(a) maintaining a market data in a database;
(b) summarizing at least a portion of said market data according to one or more sales territories selected from a market sales territory associated with the market data, thereby providing summarized market data;
(c) performing a recursive partitioning analysis on said summarized market data to thereby partition said summarized market data into a plurality of nodes which for identifying significant segmentation variables;
(d) bridging said portion of said market data with each one or more of said plurality of nodes to provide a bridged plurality of nodes; and
(e) retaining an association between said at least a portion of said market data and each bridged plurality of nodes as an additional segmentation variable.

2. The method for measuring performance discrepancies according to claim 1, wherein the step of performing a recursive partitioning analysis includes the step of displaying the plurality of nodes in a node tree with associated non-partitioned data in the database.

3. The method for measuring performance discrepancies according to claim 1, wherein the step of performing a recursive partitioning analysis includes the step utilizing an exhaustive Chi-squared automatic interactive detector.

4. The method for measuring performance discrepancies according to claim 2, further comprising the step of entering at least on additional segmentation variable based on the associated non-partitioned data.

5. The method for measuring performance discrepancies according to claim 4, further comprising the step of performing an additional partitioning analysis of the summarized market data wherein the summarized market data is partitioned into an additional plurality of nodes.

6. The method for measuring performance discrepancies according to claim 1, further comprising the step of monitoring sales performance and updating the market data.

7. The method for measuring performance discrepancies according to claim 6, further comprising the step of tracking sales performance and tracking the results of the partitioning step.

8. The method for measuring performance discrepancies according to claim 1, further comprising the step establishing a model for analysis.

9. The method for measuring performance discrepancies according to claim 8, further comprising the steps of
(i) defining a relevant market;
(ii) identifying relevant factors of the relevant market;
(iii) collecting market and sales data associated with the relevant factors; and
segmenting and sizing a market territory described by the market and sales data according to the relevant market.

10. A system for executing a computer program for measuring performance discrepancies among sales territories, comprising:
(a) a memory device for storing the computer program thereon; and
(b) a data processor, coupled to the memory device, which
(i) maintains a database of market data;
(ii) summarizes market data according to sales territory;
(iii) performs a recursive partitioning analysis of the summarized market data wherein the summarized market data is partitioned into a plurality of nodes for identifying significant segmentation variables;
(iv) bridges market data with each partitioned node; and
(v) retains an association between market data and each partitioned node as an additional segmentation variable.

11. The system for executing a computer program for measuring performance discrepancies according to claim 10, wherein the processor displays the plurality of nodes in a node tree with associated non-partitioned data

12. The system for executing a computer program for measuring performance discrepancies according to claim 10, wherein the processor performs a recursive partitioning analysis utilizing an exhaustive Chi-squared automatic interactive detector.

13. The system for executing a computer program for measuring performance discrepancies according to claim 10, wherein the processor enters additional segmentation variables based on the associated non-partitioned data.

14. The system for executing a computer program for measuring performance discrepancies according to claim 13, wherein the processor performs an additional partitioning analysis of the summarized market data wherein the summarized market data is partitioned into an additional plurality of nodes.

15. The system for executing a computer program for measuring performance discrepancies according to claim 10, wherein the processor monitors sales performance and updates the market data

16. The system for executing a computer program for measuring performance discrepancies according to claim 15, wherein the processor tracks sales performance and tracks the results of the partitioning analysis.

17. The system for executing a computer program for measuring performance discrepancies according to claim 10, wherein the processor further provides an interface for establishing a model for analysis.

18. The system for executing a computer program for measuring performance discrepancies according to claim 17, wherein the processor further provides an interface for defining a relevant market, identifying relevant factors, collecting market and sales data, and segmenting and sizing market territory.
